(19) United States
(12) Patent Application Publication
(10) Pub. No.: US 2013/0063367 A1
(43) Pub. Date: Mar. 14, 2013

(54) AIR ACTUATED DEVICE

(71) Applicant: Changsoo JANG, SanJose, CA (US)

(72) Inventor: Changsoo JANG, SanJose, CA (US)

(21) Appl. No.: 13/231,796

(22) Filed: Sep. 13, 2011

(51) Int. Cl. G06F 3/041; G06F 15/00

(52) U.S. Cl. 345/173; 702/130

(57) ABSTRACT

Air actuated devices and processes for detecting breath events are provided. The air actuated devices can include an air actuated surface having a temperature-responsive material disposed thereon. The temperature-responsive material can include multiple temperature-responsive beads or can include a temperature-responsive array having multiple temperature-responsive rows and multiple temperature-responsive columns. Monitoring circuitry can be included to monitor a parameter of the temperature-responsive material to detect a change in temperature of the air actuated surface. A processor can also be included to detect a breath event on the air actuated surface based on the monitored parameter of the temperature-responsive material. The processor can generate a command signal in response to a detected breath event. The air actuated device can also include a touch sensor to detect touch events on the air actuated surface.

### FIELD

This relates generally to input devices and, more specifically, to air actuated input devices.

### BACKGROUND

Touch sensitive devices have become popular as input devices to computing systems due to their ease and versatility of operation as well as their declining price. A touch sensitive device can include a touch sensor panel, which can be a clear panel with a touch sensitive surface, and a display device such as a liquid crystal display (LCD) that can be positioned partially or fully behind the panel or integrated with the panel so that the touch sensitive surface can cover at least a portion of the viewable area of the display device. The touch sensitive device can allow a user to perform various functions by touching the touch sensor panel using a finger, stylus or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event.

While touch sensitive devices provide intuitive ways of entering input, there can be times when it is difficult or inconvenient to physically contact the touch sensitive device.

### SUMMARY

This relates to air actuated devices and processes for detecting breath events. The air actuated devices can include an air actuated surface having a temperature-responsive material disposed thereon. The temperature-responsive material can include multiple temperature-responsive beads or can include a temperature-responsive array having multiple temperature-responsive rows and multiple temperature-responsive columns. Monitoring circuitry can be included to monitor a parameter of the temperature-responsive material to detect a change in temperature of the air actuated surface. A processor can also be included to detect a breath event on the air actuated surface based on the monitored parameter of the temperature-responsive material. The processor can generate a command signal in response to a detected breath event. The air actuated device can also include a touch sensor to detect touch events on the air actuated surface. These will be described in more detail below.

Processes for detecting breath events are also disclosed.

### BRIEF DESCRIPTION OF THE DRAWINGS

FIG. 1 illustrates a top view of an exemplary air actuated device according to various embodiments.

FIG. 2 illustrates an exemplary touch sensor panel that can be used with an air actuated device according to various embodiments.

FIG. 3 illustrates a cross-sectional view of an exemplary air actuated device having thermistor beads according to various embodiments.

FIG. 4 illustrates top view of an exemplary air actuated device having thermistor beads according to various embodiments.

FIG. 5 illustrates cross-sectional view of an exemplary air actuated device having thermistor traces according to various embodiments.

FIG. 6 illustrates a top view of an exemplary air actuated device having thermistor traces according to various embodiments.

FIG. 7 illustrates an exemplary process for detecting breath events according to various embodiments.

FIG. 8 illustrates an exemplary system for detecting breath events according to various embodiments.

FIG. 9 illustrates an exemplary personal device having an air actuated surface according to various embodiments.

FIG. 10 illustrates an exemplary personal device having an air actuated surface according to various embodiments.

FIG. 11 illustrates an exemplary personal device having an air actuated surface according to various embodiments.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to air actuated devices and processes for detecting breath events. The air actuated devices can include an air actuated surface having a temperature-responsive material disposed thereon. The temperature-responsive material can include multiple temperature-responsive beads or can include a temperature-responsive array having multiple temperature-responsive rows and multiple temperature-responsive columns. Monitoring circuitry can be included to monitor a parameter of the temperature-responsive material to detect a change in temperature of the air actuated surface. A processor can also be included to detect a breath event on the air actuated surface based on the monitored parameter of the thermistor material. The processor can generate a command signal in response to a detected breath event. The air actuated device can also include a touch sensor to detect touch events on the air actuated surface. These will be described in more detail below. Processes for detecting breath event are also disclosed.

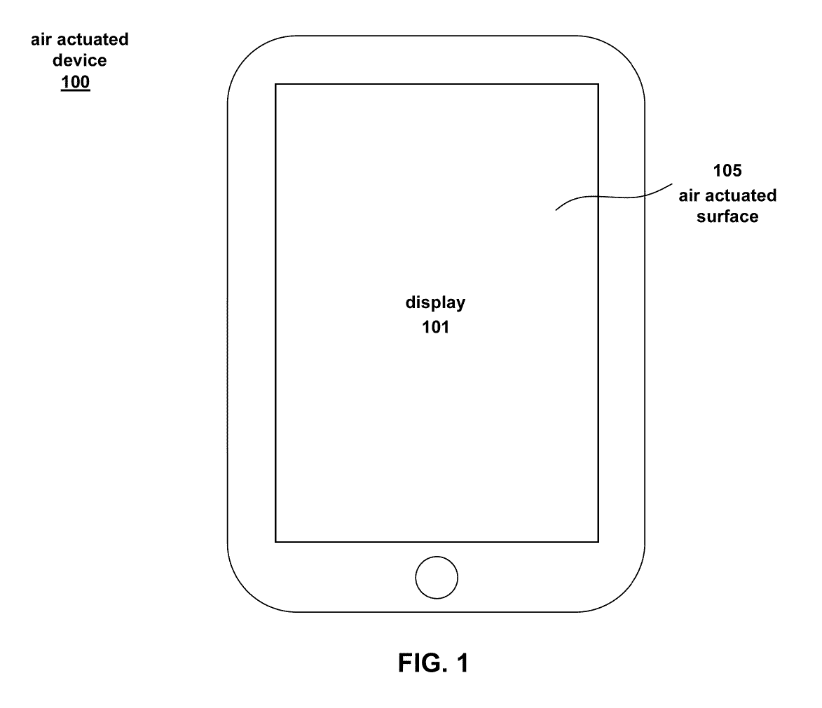

FIG. 1 illustrates s a top-view of an exemplary air actuated device 100, such as a mobile phone, tablet, touchpad, portable computer, portable media player, or the like. In some embodiments, air actuated device 100 can include display 101 that is capable of detecting touch events, such as taps, swipes, hover events, and the like. Display 101 can include a cover material (e.g., glass or plastic), a clear touch sensor panel having a touch sensitive surface positioned behind the cover material, and a display device, such as a liquid crystal display (LCD), that can be positioned partially or fully behind the touch sensor panel or integrated with the touch sensor panel so that the touch sensitive surface can cover at least a portion of the viewable area of display 101. Display 101 can allow a user to perform various functions by touching the touch sensor panel using a finger, stylus or other object. In other embodiments, display 101 can be a non-touch sensitive display.

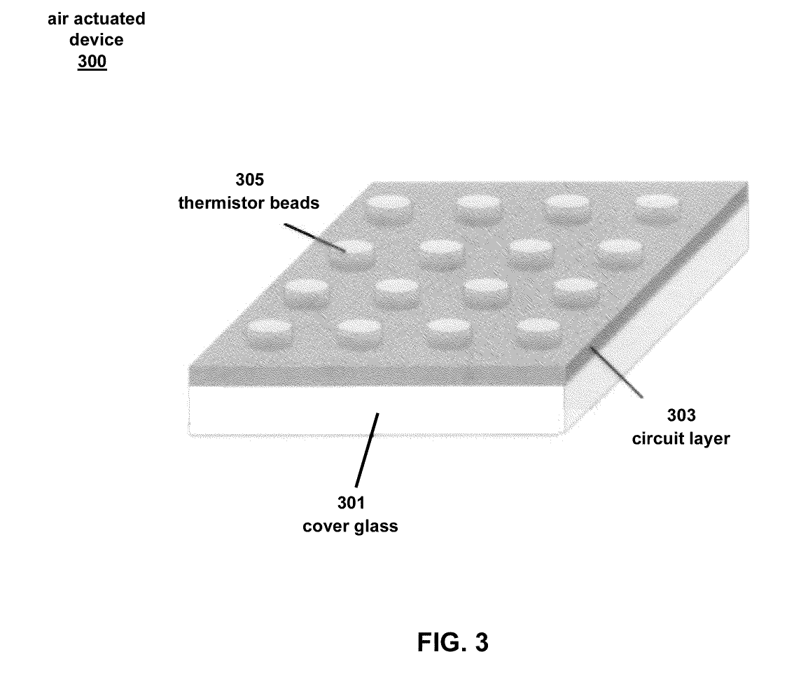

In some embodiments, device 100 can further include an air actuated surface 105 for detecting breath events, such as a user breathing or blowing across a surface of the device. In some embodiments, air actuated surface 105 can be located on the entire viewable area of display 101, while in other embodiments, air actuated surface 105 can be located on only a portion of display 101. Air actuated surface 105 can include a temperature-responsive material, such as a thermistor material, deposited on the surface of the device, such as on the surface of the cover material of display 101. As will be described in greater detail below with respect to FIGS. 3-6, the thermistor material can be used to detect a change in temperature caused by the breath of a user. This can allow a user to enter a command by blowing across air actuated surface 105 of device 100.

While specific examples of air actuated device 100 are provided above, it should be appreciated that the principles described in the present disclosure can similarly be applied to devices having other features and configurations. For instance, the circuitry described below for detecting breath events can be applied to touch sensitive devices, such as touch pads, touch sensitive displays, and the like, as well as non-touch sensitive devices, such as non-touch sensitive displays, non-touch sensitive surfaces of a device, and the like.

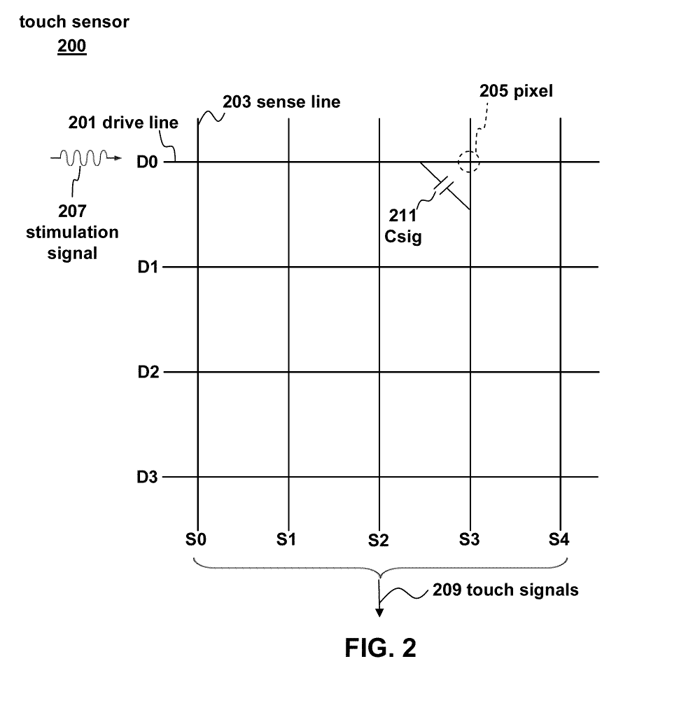

As mentioned above, air actuated device 100 can include a touch sensitive display 101. In these embodiments, a touch sensor, such as touch sensor 200 shown in FIG. 2, can be used to detect touch events on air actuated device 100. Touch sensor 200 can include an array of pixels 205 that can be formed at the crossing points between rows of drive lines 201 (D0-D3) and columns of sense lines 203 (S0-S4). Each pixel 205 can have an associated mutual capacitance Csig 211 formed between the crossing drive lines 201 and sense lines 203 when the drive lines are stimulated. The drive lines 201 can be stimulated by stimulation signals 207 provided by drive circuitry (not shown) and can include an alternating current (AC) waveform. The sense lines 203 can transmit touch or sense signals 209 indicative of a touch at the panel 200 to sense circuitry (not shown), which can include a sense amplifier for each sense line.

To sense a touch at the touch sensor 200, drive lines 201 can be stimulated by the stimulation signals 207 to capacitively couple with the crossing sense lines 203, thereby forming a capacitive path for coupling charge from the drive lines 201 to the sense lines 203. The crossing sense lines 203 can output touch signals 209, representing the coupled charge or current. When a user's finger (or other object) touches the panel 200, the finger can cause the capacitance Csig 211 to reduce by an amount ΔCsig at the touch location. This capacitance change ΔCsig can be caused by charge or current from the stimulated drive line 201 being shunted through the touching finger to ground rather than being coupled to the crossing sense line 203 at the touch location. The touch signals 209 representative of the capacitance change ΔCsig can be transmitted by the sense lines 203 to the sense circuitry for processing. The touch signals 209 can indicate the pixel where the touch occurred and the amount of touch that occurred at that pixel location.

While the embodiment shown in FIG. 2 includes four drive lines 201 and five sense lines 203, it should be appreciated that touch sensor 200 can include any number of drive lines 201 and any number of sense lines 203 to form the desired number and pattern of pixels 205. Additionally, while the drive lines 201 and sense lines 203 are shown in FIG. 2 in a crossing configuration, it should be appreciated that other configurations are also possible to form the desired pixel pattern. While FIG. 2 illustrates mutual capacitance touch sensing, other touch sensing technologies may also be used in conjunction with embodiments of the disclosure, such as self-capacitance touch sensing, resistive touch sensing, projection scan touch sensing, and the like. Furthermore, while various embodiments describe a sensed touch, it should be appreciated that the touch sensor 200 can also sense a hovering object and generate hover signals therefrom.

FIG. 3 illustrates a cross-sectional view of a front portion of an exemplary air actuated device 300. Air actuated device 300 is an example of air actuated device 100. In some embodiments, air actuated device 300 can include cover glass 301 (or other cover material) positioned over a touch sensor (not shown) similar or identical to touch sensor 200 of FIG. 2. The touch sensor can be arranged to detect touch events on the surface of cover glass 301. In other embodiments, air actuated device 300 may not include a touch sensor.

Air actuated device 300 can further include multiple thermistor beads 305 for detecting a change in temperature on the surface of cover glass 301. In some embodiments, thermistor beads 305 can be used to detect a change in temperature caused by the breath of a user. For example, as a user blows across the surface of cover glass 301, the temperature of the surface of cover glass 301 can change due to the difference in temperature between cover glass 301 and the user's breath. In response to the detected change in temperature, a processor within device 300 can be configured to generate a command signal to cause device 300 to perform an action. For example, a user can blow on the display of device 300 to cause an action to be performed in a game, a page of an electronic book to be turned, or any other action to be performed in an application. It should be noted that although thermistors are illustrated and described herein, other embodiments of the disclosure can utilize resistive thermal devices (RTDs), thermocouples or any other temperature-responsive materials, beads or devices having one or more properties that change as a function of temperature.

Thermistor beads 305 can be made of any thermistor material, such as a metal oxide. In some embodiments, since thermistor beads 305 can be located on the portion of cover glass 301 above the device's display, thermistor beads 305 can be made of a transparent material so as not to obstruct the user's view. For example, a transparent metal oxide, such as nickel oxide, can be used in some embodiments. Since thermistor beads 305 can be made of a thermistor material, a parameter, such as the resistance of thermistor beads 305, can change with temperature. Thus, device 300 can use thermistor beads 305 to detect a change in temperature by monitoring the change in resistance of each bead.

In some embodiments, device 300 can further include circuit layer 303 for monitoring a parameter, such as the resistance, of thermistor beads 305. Circuit layer 303 can include circuitry configured to monitor a change in voltage across each bead or to monitor a change in current through each bead. For example, in some embodiments, circuit layer 303 can include circuitry configured to flow a constant current through each thermistor bead 305 and monitor a change in voltage across each bead. In other embodiments, circuit layer 303 can include circuitry configured to apply a constant voltage across each thermistor bead 305 and monitor a change in current conducted through each bead. In yet other embodiments, circuit layer 303 can include other monitoring circuitry known to those of ordinary skill in the art.

In some embodiments, circuit layer 303 can be positioned across cover glass 301 beneath thermistor beads 305. In this way, circuit layer 303 can couple to each thermistor bead 305. In some embodiments, since circuit layer 303 can be located on the portion of cover glass 301 above the device's display, circuit layer 303 can be made of a transparent material so as not to obstruct the user's view. For example, a transparent metal oxide, such as indium-tin oxide (ITO), can be used in some embodiments.

In some embodiments, since thermistor beads 305 can be located on the upper surface of cover glass 301 where users typically touch device 300, a protective film (which can be thermally conductive) can be placed over thermistor beads 305 on cover glass 301. The protective film can be used to protect thermistor beads 305 from being damaged or removed from device 300 by the user's finger or by inadvertent contact with another object. In some embodiments, the protective film can be formed from or coated with an oleophobic material, such as fluorocarbons, to reduce the amount of oil on the protective film that can be deposited by the user's finger.

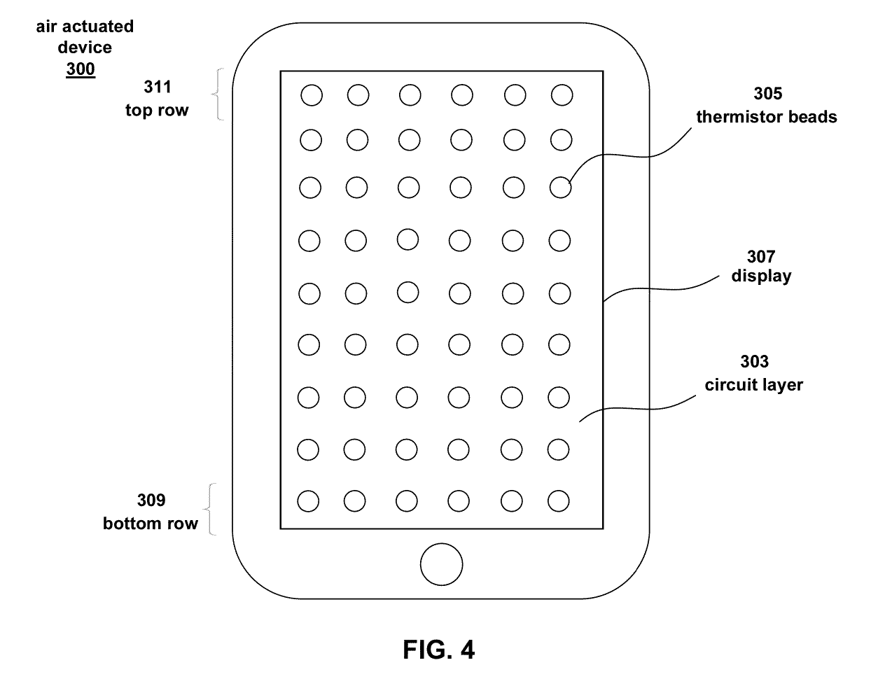

In some embodiments, thermistor beads 305 can be arranged in rows and columns to form an array of beads. For example, FIG. 4 shows a top-view of device 300 having multiple thermistor beads 305 arranged along the portion of cover glass 301 (or other cover material) covering display 307. While 54 thermistor beads 305 are shown arranged in rows and columns, it should be appreciated that any number of beads can be used and can be arranged in any pattern depending on the desired resolution of breath detection. Additionally, thermistor beads 305 are not drawn to scale and are shown for explanation purposes only. As mentioned above, thermistor beads 305 can be formed of a transparent material, allowing the user to see an image projected through display portion 307.

In some embodiments, air actuated device 300 can further include a processor (not shown) for receiving signals from circuit layer 303 that are representative of a change in temperature of each thermistor bead 305. The processor can use this information to determine if a breath event has been detected. Information, such as the amount of change in temperature, duration of the change in temperature, location of thermistor beads 305 detecting a change in temperature, and the like, can be used to identify a breath event. For example, a breath can cause a relatively small change in temperature for a relatively short period of time. Thus, in some embodiments, a detected change in temperature of between a fraction of a degree (e.g., 0.1° C. to 0.9° C.) to several degrees (e.g., 3° C. to 5° C.) for a duration between a fraction of a second (e.g., 0.1 seconds to 0.9 seconds) to tens of seconds (e.g., 10 seconds to 30 seconds) can be indicative of a user's breath on cover glass 301 of device 300. Additionally, the location of a user's breath can typically be decentralized. In other words, a breath event typically extends over a large portion of display 307 rather than a small discrete portion of display 307, as would be expected from a user physically touching the device. As a result, a breath event can cause a large number of grouped thermistor beads 305 to detect a change in temperature. Thus, in some embodiments, a breath event can be identified by the processor when a detection of a small change in temperature (e.g., a temperature change of between 0.1° C. to 5° C.) for a short duration (e.g., a duration between 0.1 seconds to 30 seconds) by a large number of grouped thermistor beads 305 (e.g., thermistor beads 305 covering between about 30% to 50% of display 307). While specific temperatures, durations, and number of thermistor beads 305 are provided above, it should be appreciated that other values can be used depending on the specific application. These values can be determined, for example, by experimentation for specific device configurations.

In response to a detection of a breath event, the processor can be configured to generate a command signal to cause device 300 to perform an action. For example, the command signal can cause an action to be performed in a game, a page to be turned in an electronic book, or any other action to be performed in any application. The command can be a simple binary command (e.g., perform action or do not perform action) or can include additional information about the breath event, such as duration, intensity, direction, or the like. For example, in some embodiments, the duration that a temperature change is detected can be used to approximate the duration of the breath event. In other embodiments, the time that circuit layer 303 reports a change in temperature for a particular thermistor bead 305 can be used to determine the direction and intensity of the breath. For example, if a change in temperature is first detected at a thermistor bead 305 located in bottom row 309 and is progressively followed by a detection of a change in temperature by thermistor beads 305 from bottom row 309 to top row 311, the breath can be determined to originate at the bottom of display 307 and be directed up towards the top of display 307. Similarly, the time between thermistor beads 305 detecting a change in temperature can be used to approximate the intensity, or speed, of the breath event.

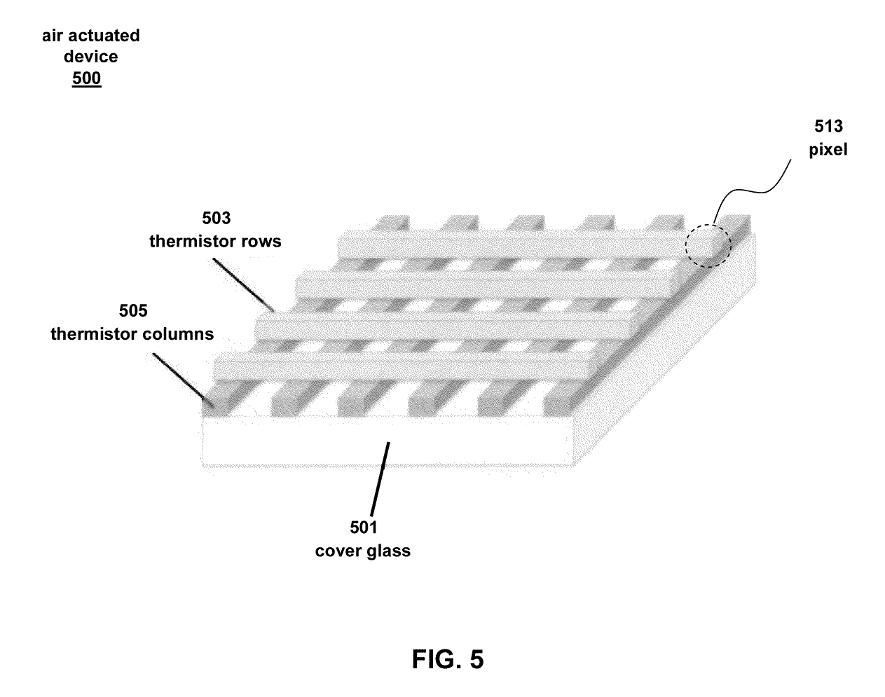

FIG. 5 illustrates a cross-sectional view of a front portion of an exemplary air actuated device 500. Air actuated device 500 is another example of air actuated device 100. Similar to air actuated device 300, in some embodiments, air actuated device 500 can include cover glass 501 (or other cover material) positioned over a touch sensor (not shown) similar or identical to touch sensor 200 of FIG. 2. The touch sensor can be arranged to detect touch events on the surface of cover glass 501. In other embodiments, air actuated device 500 may not include a touch sensor.

Air actuated device 500 can further include an array of thermistor rows 503 and thermistor columns 505 for detecting a change in temperature on the surface of cover glass 501. Similar to thermistor beads 301 of device 300, thermistor rows 503 and thermistor columns 505 can be used to detect a change in temperature caused by the breath of a user. For example, the intersections of thermistor rows 503 and thermistor columns 505 can form pixels 513 that can be used to detect breath events in a manner similar to that of thermistor beads 305. A change in temperature of a pixel 513 can be determined based on the pixel's corresponding thermistor row 503 and thermistor column 505 detecting a change in temperature.

Thermistor rows 503 and thermistor columns 505 can be made from traces of any thermistor material, such as a metal oxide. In some embodiments, since thermistor rows 503 and thermistor columns 505 can be located on the portion of cover glass 505 (or other cover material) above the device's display, thermistor rows 503 and thermistor columns 505 can be made of a transparent material so as not to obstruct the user's view. For example, a transparent metal oxide, such as nickel oxide, can be used in some embodiments. Additionally, since thermistor rows 503 and thermistor columns 505 can be made of a thermistor material, the resistance of thermistor rows 503 and thermistor columns 505 can change with temperature. Thus, device 500 can use thermistor rows 503 and thermistor columns 505 to detect a change in temperature by monitoring the change in resistance of the traces.

In some embodiments, device 500 can further include monitoring circuitry (not shown) for monitoring the resistance of thermistor rows 503 and thermistor columns 505. The monitoring circuitry can include circuitry configured to monitor a change in voltage across each trace or to monitor a change in current through each trace. For example, in some embodiments, the monitoring circuitry can include circuitry configured to flow a constant current through each trace of thermistor rows 503 and thermistor columns 505 and monitor a change in voltage across each trace. In other embodiments, the monitoring circuitry can include circuitry configured to apply a constant voltage across each trace of thermistor rows 503 and thermistor columns 505 and monitor a change in current conducted through each trace. In yet other embodiments, the monitoring circuitry can include other monitoring circuitry known to those of ordinary skill in the art.

In some embodiments, the monitoring circuitry can be positioned along the edges of device 500 behind the black mask on cover glass 501 (or other cover material). Unlike thermistor beads 305 of device 300, each thermistor row 503 and thermistor column 505 can span the width and length, respectively, of the display of device 500. As a result, the monitoring circuitry used to monitor the resistance of thermistor rows 503 and thermistor columns 505 can be coupled to the ends of the traces and can thus be located away from the display portion of device 500. As a result, thermistor rows 503 and thermistor columns 505 can be formed using non-transparent materials or transparent materials.

In some embodiments, since thermistor rows 503 and thermistor columns 505 can be located on the upper surface of cover glass 501 (or other cover material) where users typically touch device 500, a protective film can be placed over thermistor rows 503 and thermistor columns 505 on cover glass 501. The protective film can be used to protect thermistor rows 503 and thermistor columns 505 from being damaged or removed from device 500 by the user's finger or by inadvertent contact with another object. In some embodiments, the protective film can be formed or coated with an oleophobic material, such as fluorocarbons, to reduce the amount of oil on the protective film that can be deposited by the user's finger.

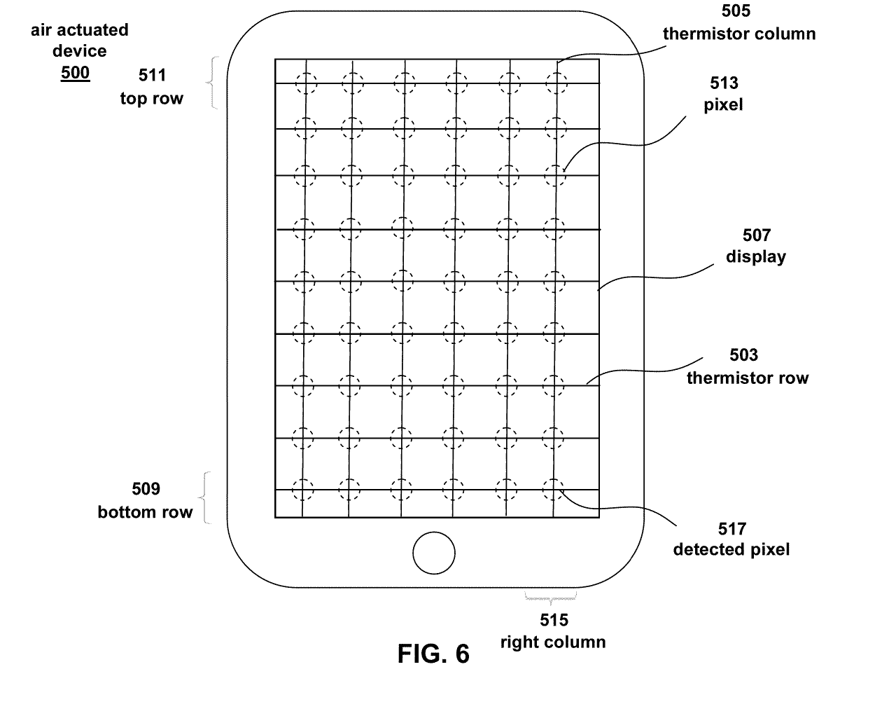

FIG. 6 shows a top-view of device 500 having multiple thermistor rows 503 and multiple thermistor columns 505 arranged on the portion of cover glass 501 covering display portion 507. The intersections of thermistor rows 503 and thermistor columns 505 form pixels 513 that can be used to detect a change in temperature on cover glass 501. While nine thermistor rows 503 and six thermistor columns 505 forming 54 pixels 513 are shown, it should be appreciated that any number of thermistor rows 503 and thermistor columns 505 can be used and can be arranged in any pattern depending on the desired resolution of breath detection. Additionally, thermistor rows 503 and thermistor columns 505 are not drawn to scale and are shown for explanation purposes only. As mentioned above, thermistor rows 503 and thermistor columns 505 can be formed of a transparent material, allowing the user to see an image projected through display portion 507.

Air actuated device 500 can further include a processor (not shown) for receiving signals from the monitoring circuitry that are representative of a change in temperature of thermistor rows 503 and thermistor columns 505. The signals can be representative of a change in temperature of each thermistor trace. The processor can use this information to determine a location of a pixel 513 where a change in temperature has occurred. For example, if both bottom thermistor row 509 and right thermistor column 515 detect a change in temperature, the processor can determine that a change in temperature has been detected at detected pixel 517. The processor can use this information, along with additional information, such as the amount of change in temperature, duration of change in temperature, location of pixels 517 detecting a change in temperature, and the like, to determine if a breath event has occurred. For example, as mentioned above, a breath event can cause a relatively small change in temperature for a relatively short period of time. Thus, in some embodiments, a detected change in temperature of between a fraction of a degree (e.g., 0.1° C. to 0.9° C.) to several degrees (e.g., 3° C. to 5° C.) for a duration between a fraction of a second (e.g., 0.1 seconds to 0.9 seconds) to tens of seconds (e.g., 10 seconds to 30 seconds) can be indicative of a user's breath on cover glass 501 (or other cover material) of device 500. Additionally, the location of a user's breath can typically be decentralized. In other words, a breath event typically extends over a large portion of display 507 rather than a small discrete portion of display 507, as would be expected from a user physically touching the device. As a result, a breath event can cause a large number of grouped pixels 513 to detect a change in temperature. Thus, in some embodiments, a breath event can be identified by the processor when a detection of a small change in temperature (e.g., a temperature change of between 0.1° C. to 5° C.) for a short duration (e.g., a duration between 0.1 seconds to 30 seconds) by a large number of grouped pixels 513 (e.g., pixels 513 covering between about 30% to 50% of display 507). While specific temperatures, durations, and number of pixels 513 are provided above, it should be appreciated that other values can be used depending on the specific application. These values can be determined, for example, by experimentation for specific device configurations.

In response to a detection of a breath event, the processor can be configured to generate a command signal to cause device 500 to perform an action. For example, the command can cause an action to be performed in a game, a page to be turned in an electronic book, or any other action to be performed in any application. The command can be a simple binary command (e.g., perform action or do not perform action) or can include additional information about the breath event, such as duration, intensity, direction, or the like. For example, in some embodiments, the duration that a temperature change is detected can be used to approximate the duration of the breath event. In other embodiments, the time that the monitoring circuitry reports a change in temperature for traces corresponding to a particular pixel 513 can be used to determine the direction and intensity of the breath. If a change in temperature is first detected at a pixel 513 located in bottom row 509 and is progressively followed by a detection of a change in temperature at pixels 513 from bottom row 509 to top row 511, the breath can be determined to originate at the bottom of display 507 and be directed up towards the top of display 507. Similarly, the time between detection of a change in temperature at pixels 513 can be used to approximate the intensity, or speed, of the breath event.

In some embodiments, the thermistor materials of air actuated devices 100, 300, and 500 can be deposited on the cover glass (or other cover material) using a chemical vapor deposition (CVD) process, physical vapor deposition (PVD) process, or sputtering process. In other embodiments, other deposition processes known to those of ordinary skill in the art can be used.

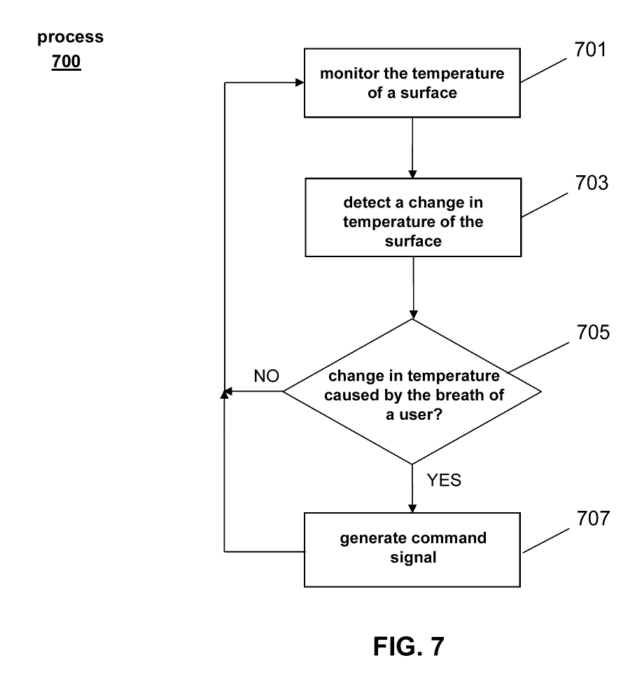

FIG. 7 shows an exemplary process 700 for detecting a breath event on a surface of an air actuated device. In some embodiments, process 700 can be used to detect a user's breath across a display of an air actuated device that is similar or identical to device 100, 300, or 500.

At block 701 of process 700, a temperature of a surface of a device can be monitored. In some embodiments, multiple thermistor beads similar or identical to thermistor beads 305 can be positioned on the surface of the device, such as on a display of a touch sensitive device. Circuitry similar or identical to circuit layer 303 can be used to monitor the temperature of the surface by monitoring a parameter, such as resistance, of the thermistor beads, as described above with respect to FIGS. 3 and 4.

In other embodiments, thermistor traces similar or identical to thermistor rows 503 and thermistor columns 505 can be arranged on the surface of the device. Monitoring circuitry can be used to monitor the temperature of the surface by monitoring the resistance of the traces, as described above with respect to FIGS. 5 and 6.

At block 703, a change in temperature of the surface of the device can be detected. In some embodiments, as described above, the change in temperature can be detected by monitoring the resistance of the thermistor beads or thermistor traces.

At block 705, it can be determined whether the detected change in temperature was caused by the breath of a user. As described above with respect to FIGS. 3-6, the amount of change in temperature, duration of the change in temperature, location of the change in temperature, and the like, can be used to identify a breath event. If, at block 705, it is determined that the change in temperature was not caused by the breath of the user, the process can repeat back to block 701. If, however, it is determined that the change in temperature was caused by the breath of the user, the process can proceed to block 707.

At block 707, a command signal can be generated. In some embodiments, as described above with respect to FIGS. 3-6, a processor can be used to generate a command signal indicative of a detected breath event. This signal can cause the device or a computing system associated with the device to perform some action in response to the signal. For example, the command signal can cause an action to be performed in a game, a page to be turned in an electronic book, or any other action to be performed in any application. The command can be a simple binary command (e.g., perform action or do not perform action) or can include additional information about the breath event, such as duration, intensity, direction, or the like. The process can then repeat back to block 701.

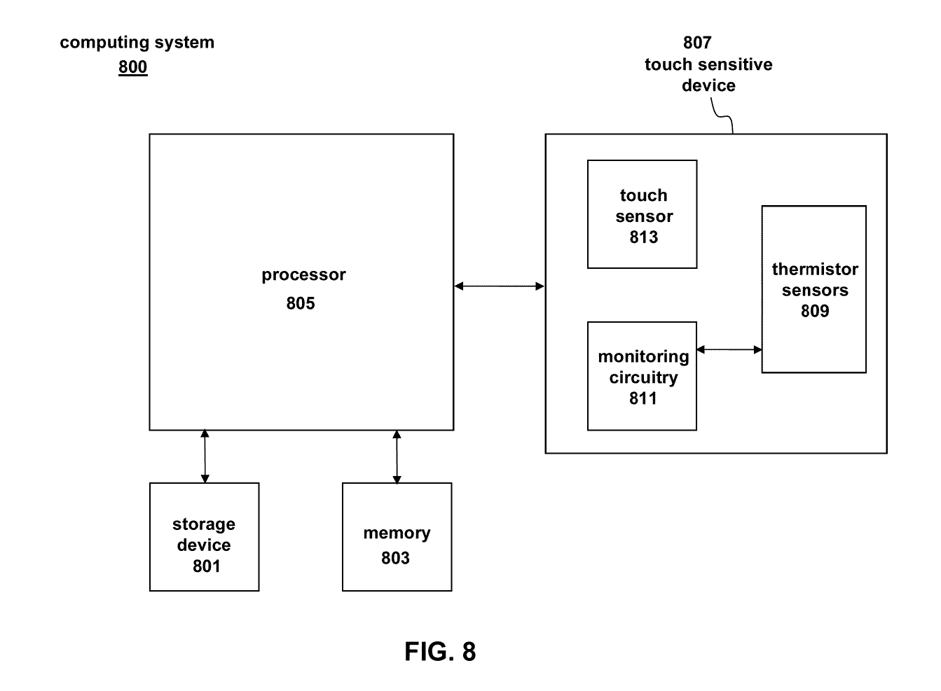

One or more of the functions relating to the detection of a breath event can be performed by a computing system similar or identical to computing system 800 shown in FIG. 8. Computing system 800 can include instructions stored in a non-transitory computer readable storage medium, such as memory 803 or storage device 801, and executed by processor 805. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

Computing system 800 can further include air actuated device 807 coupled to processor 805. Air actuated device 807 can be similar or identical to air actuated device 100, 300, or 500 described above. In some embodiments, air actuated device 807 can include thermistor sensors 809, monitoring circuitry 811, and touch sensor 813 for detecting touch events and breath events and for providing signals indicating a detection of a touch event or breath event to processor 805. In some embodiments, thermistor sensors 809 can include sensors similar or identical to thermistor beads 305 or thermistor rows 503 and thermistor columns 505, monitoring circuitry 811 can include circuitry to monitor the resistance of thermistor sensors 809 and can include circuitry similar or identical to circuit layer 303 of device 300 or the monitoring circuitry of device 500, and touch sensor 813 can be similar or identical to touch sensor 200, described above. Processor 805 can receive the signals from air actuated device 807 and interpret them as touch events or breath events in a manner similar or identical to that described above with respect to process 700.

It is to be understood that the computing system is not limited to the components and configuration of FIG. 8, but can include other or additional components in multiple configurations according to various embodiments. Additionally, the components of computing system 800 can be included within a single device, or can be distributed between two or more devices. For example, while processor 805 is shown separate from air actuated device 807, in some embodiments, processor 805 can be located within air actuated device 807.

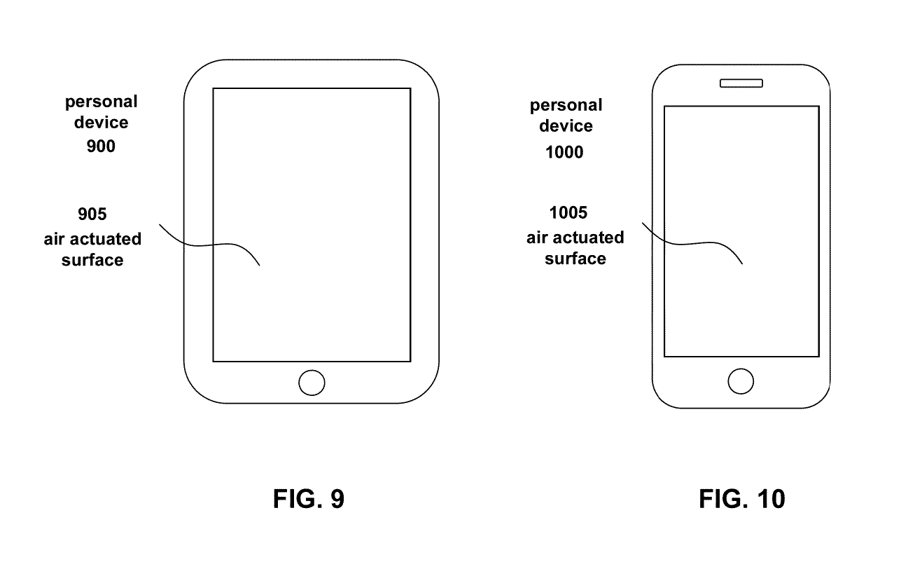

FIG. 9 illustrates an exemplary personal device 900, such as a tablet, that can include an air actuated surface 905 according to various embodiments.

FIG. 10 illustrates another exemplary personal device 1000, such as a mobile phone, that can include an air actuated surface 1005 according to various embodiments.

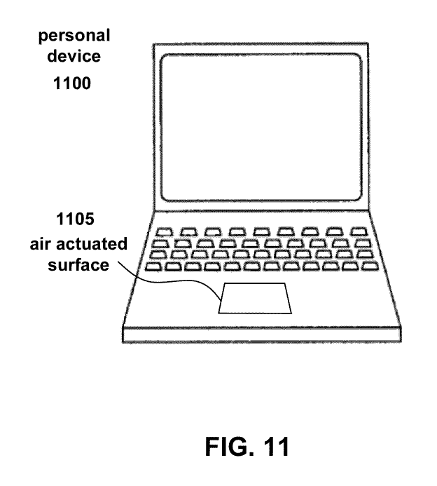

FIG. 11 illustrates another exemplary personal device 1100, such as a laptop computer, that can include an air actuated surface 1105 according to various embodiments.

The personal devices of FIGS. 9-11, as well as other computing devices, can receive both touch input and breath input by utilizing a touch sensitive display at least partially coated with a thermistor material according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A device comprising:
a temperature-responsive material disposed on a device, wherein a parameter changes in response to a change in temperature of the temperature-responsive material;
monitoring circuitry coupled to the temperature-responsive material, wherein the monitoring circuitry is configured to monitor the parameter; and
a processor coupled to the monitoring circuitry, wherein the processor is configured to detect a breath event based on the parameter, and wherein the processor is further configured to generate a command signal in response to a detection of the breath event.

2. The device of claim 1, wherein the temperature-responsive material comprises a plurality of thermistor beads.

3. The device of claim 1, wherein the temperature-responsive material comprises a plurality of thermistor rows and a plurality of thermistor columns.

4. The device of claim 1, wherein the temperature-responsive material is disposed on a touch sensitive surface of the device.

5. The device of claim 1 further comprising a protective film covering the temperature-responsive material.

6. A display device comprising:
a cover material;
a plurality of temperature-responsive beads disposed on a surface of the cover material, wherein a parameter changes in response to a change in temperature of at least one of the temperature-responsive beads;
monitoring circuitry coupled to the plurality of temperature-responsive beads, wherein the monitoring circuitry is configured to monitor the parameter for each of the plurality of temperature-responsive beads; and
a processor coupled to the monitoring circuitry, wherein the processor is configured to detect a breath event based on the parameter for each of the plurality of temperature-responsive beads, and wherein the processor is further configured to generate a command signal in response to a detection of the breath event.

7. The display device of claim 6 further comprising a touch panel positioned behind the cover material.

8. The display device of claim 6, wherein the plurality of temperature-responsive beads are formed from a substantially transparent material.

9. The display device of claim 6, wherein the monitoring circuitry is positioned on the cover material, and wherein the plurality of temperature-responsive beads are positioned on the monitoring circuitry.

10. The display device of claim 6, further comprising an oleophobic protective film covering the plurality of temperature-responsive beads.

11. A display device comprising:
a cover material;
a temperature-responsive array disposed on a surface of the cover material, wherein the temperature-responsive array comprises:
a plurality of temperature-responsive rows disposed on the surface of the cover material; and
a plurality of temperature-responsive columns disposed on the surface of the cover material, wherein the plurality of temperature-responsive columns intersect the plurality of temperature-responsive rows to form a plurality of temperature-responsive sensor pixels;
monitoring circuitry coupled to the temperature-responsive array, wherein the monitoring circuitry is configured to monitor a parameter for each of the plurality of temperature-responsive rows and each of the plurality of temperature-responsive columns; and
a processor coupled to the temperature-responsive array, wherein the processor is configured to detect a change in the parameter for a temperature-responsive sensor pixel based on a change in of the parameter for a corresponding temperature-responsive row and a corresponding temperature-responsive column.

12. The display device of claim 11, wherein the processor is further configured to detect a breath event based on a detected change in the parameter for one or more temperature-responsive sensor pixels of the plurality of temperature-responsive sensor pixels, and wherein the processor is further configured to generate a command signal in response to a detection of the breath event.

13. The display device of claim 12, wherein the breath event comprises warm air directed towards the surface of the cover material.

14. The display device of claim 11, wherein the display device is configured to change a page of an electronic book displayed on the device in response to the command signal.

15. The display device of claim 11 further comprising a touch panel positioned behind the cover material, wherein the touch panel is configured to detect a touch event on the surface of the cover material.

16. A method for detecting a flow of air across a surface of a cover material of a display, the method comprising:
monitoring a temperature of the surface of the cover material; and
generating a command signal indicating that the flow of air has been detected, wherein the command signal is generated in response to a change in the temperature of the surface of the cover material.

17. The method of claim 16, wherein the temperature of the surface of the cover material is monitored using a plurality of temperature-responsive beads and monitoring circuitry coupled to the plurality of temperature-responsive beads.

18. The method of claim 17, wherein monitoring the temperature of the surface of the cover material comprises monitoring a parameter of each of the plurality of temperature-responsive beads.

19. The method of claim 16, wherein the temperature of the surface of the cover material of is monitored using a temperature-responsive array comprising:
a plurality of temperature-responsive rows disposed on the surface of the cover material; and
a plurality of temperature-responsive columns disposed on the surface of the cover material, wherein the plurality of temperature-responsive columns intersect the plurality of temperature-responsive rows to form a plurality of temperature-responsive sensor pixels.

20. The method of claim 19, wherein monitoring the temperature of the surface of the cover material comprises detecting a change in temperature of a temperature-responsive sensor pixel based on a change in a parameter of a corresponding temperature-responsive row and a corresponding temperature-responsive column.

21. A non-transitory computer readable storage medium having computer-executable instructions stored therein, which, when executed by an apparatus including a display, detects a breath event on a surface of the display by causing the apparatus to perform a method comprising:
monitoring a temperature of a surface of a cover material of the display;
detecting the breath event based on a change in the temperature of the surface of the cover material; and
generating a command signal in response to a detection of the breath event.

22. The non-transitory computer readable storage medium of claim 21, wherein the breath event comprises warm air directed towards the surface of the cover material.

23. The non-transitory computer readable storage medium of claim 21, wherein the display further comprises a touch panel configured to detect a touch event on the surface of the cover material, and wherein the method further comprises monitoring the surface of the cover material for the touch event.

24. The non-transitory computer readable storage medium of claim 23, wherein the touch event comprises a tap or a swipe on the cover material.

25. The non-transitory computer readable storage medium of claim 21, wherein the command signal comprises at least one of duration, intensity, or direction information associated with the breath event.
